(19) United States
(12) Patent Application Publication
(10) Pub. No.: US 2006/0282988 A1
(43) Pub. Date: Dec. 21, 2006

(54) Control structure of retractable handle

(76) Inventor: Thomas Lin, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/156,596

(22) Filed: Jun. 21, 2005

(51) Int. Cl. B25G 1/04

(52) U.S. Cl. 16/429

(57) ABSTRACT

A retractable handle control structure, which is used in a retractable handle formed of a tube set and a positioning device, includes a rotary knob connected to one end of the tube set of the retractable handle and rotatable by an external force to move the positioning device between a locking position and an unlocking position to lock and unlock the tube set for controlling adjustment of the length of the tube set, and a sleeve sleeved onto the tube set and connected to the rotary knob for turning by the user to rotate the rotary knob and to further move the positioning device between the locking position and the unlocking position.

### BACKGROUND OF THE INVENTION

1. Field of the Invention

The present invention relates to a retractable handle for hand tool and more particularly, to a retractable handle control structure for controlling adjustment of the length of the retractable handle.

2. Description of the Related Art

A hand tool may be provided with a retractable handle that can be adjusted to the desired length subject to different working requirements. A retractable handle for this purpose generally comprises a tube set, a positioning device, and a rotary knob. The tube set comprises an inner tube and an outer tube sleeved onto the inner tube. The positioning device is mounted inside the tube set for locking the inner tube to the outer tube. The rotary knob is pivoted to the bottom end of the tube set, and rotatable by the user to move the positioning device between the locking position to lock the inner tube to the outer tube and the unlocking position to unlock the inner tube from the outer tube.

Because the rotary knob is provided at the bottom end of the tube set, the user must move the hand to the bottom side of the tube set so as to rotary the rotary knob. When adjusting the length of the retractable handle, the user cannot hold the retractable handle positively, and the hand tool may slip from the hands and fall to the ground accidentally.

### SUMMARY OF THE INVENTION

The present invention has been accomplished under the circumstances in view. It is the main object of the present invention to provide a retractable handle control structure, which facilitates adjustment of the length of the retractable handle conveniently.

To achieve this object of the present invention, the retractable handle control structure is used in a retractable handle comprised of a tube set and a positioning device. The retractable handle control structure comprises a rotary knob connected to one end of the tube set of the retractable handle and rotatable by an external force to move the positioning device between a locking position and an unlocking position to lock and unlock the tube set for controlling adjustment of the length of the tube set; and a sleeve sleeved onto the tube set and connected to the rotary knob for turning by the user to rotate the rotary knob and to further move the positioning device between the locking position and the unlocking position.

### BRIEF DESCRIPTION OF THE DRAWINGS

FIG. 1 is an exploded view of the preferred embodiment of the present invention.

FIG. 2 is a front view of the preferred embodiment of the present invention.

FIG. 3 is a sectional view taken along line 3-3 of FIG. 2.

FIG. 4 is a side view of the preferred embodiment of the present invention.

FIG. 5 is similar to FIG. 4 but showing the rotary knob rotated with the sleeve.

### DETAILED DESCRIPTION OF THE INVENTION

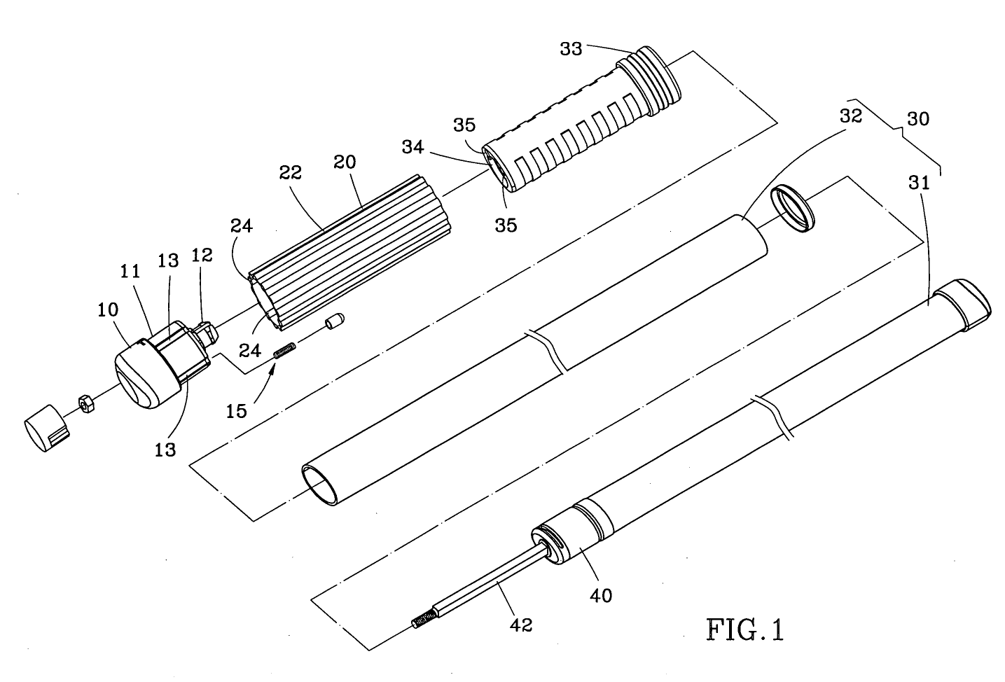

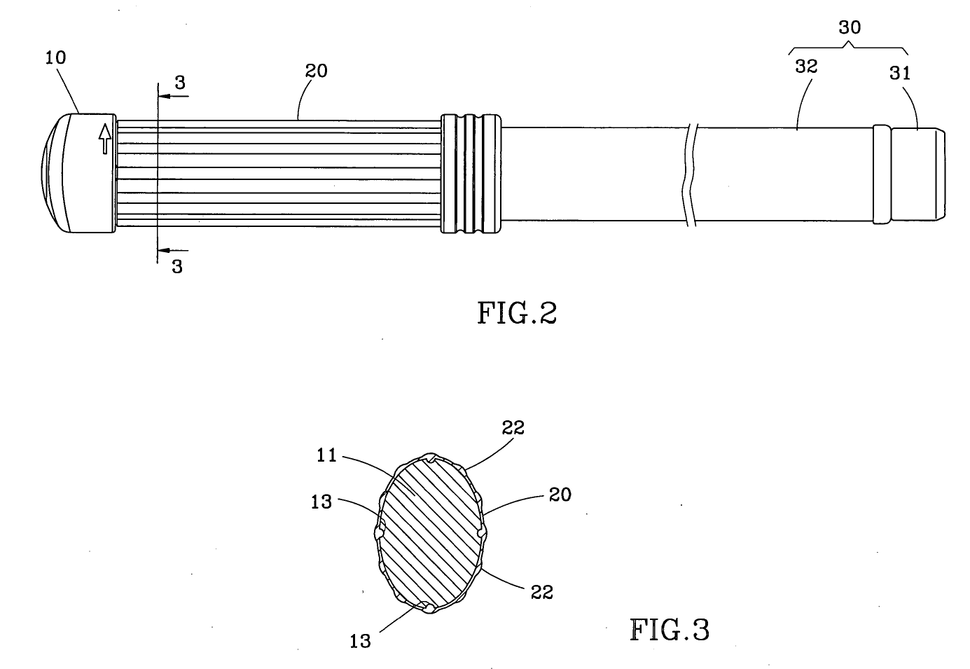

Referring to FIGS. 1 and 2, a control structure is shown used in a retractable handle comprised of a tube set 30 and a positioning device 40. The control structure is comprised of a rotary knob 10 and a sleeve 20.

The tube set 30 is comprised of an inner tube 31 and an outer tube 32. The inner tube 31 and the outer tube 32 commonly have an oval cross section. The positioning device 40 is provided at one end of the inner tube 31. The outer tube 32 is sleeved onto the inner tube 31. By means of stopping the positioning device 40 against the inside wall of the outer tube 32 or releasing the positioning device 40 from the inside wall of the outer tube 32 to change the relative position between the inner tube 31 and the outer tube 32, the length of the tube set 32 is relatively changed. The outer tube 32 has a locating block 33 fixedly fastened to the bottom end thereof. The locating block 33 has a through hole 34 axially extending through two distal ends thereof in communication with the inside space of the outer tube 32, and two bottom recesses 35 formed in the bottom end at two sides of the through hole 34.

The rotary knob 10 comprises a coupling portion 11, a hook 12 forwardly extending from the top side of the coupling portion 11, and four longitudinal grooves 13 spaced around the periphery of the coupling portion 11. The shape of the cross section of the hook 12 fits the shape of the cross section o the through hole 34. The longitudinal grooves 13 are formed in the periphery of the coupling portion 11 and longitudinally extending from the top side of the coupling portion 11 to a certain distance toward the bottom side of the coupling portion 11. The hook 12 is inserted through the through hole 34 of the locating block 33 and hooked in a part inside the locating block 33 to secure the rotary knob 10 to the locating block 33, allowing rotation of the rotary knob 10 relative to the locating block 33. A link 42 is connected between the rotary knob 10 and the inner tube 31 for enabling the inner tube 31 to be rotated with the rotary knob 10 relative to the outer tube 32 between an engagement position where the inner tube 31 and the outer tube 32 are firmly stopped against each other and a disengagement position where the inner tube 31 is disengaged from the outer tube 32 and axially movable relative to the outer tube 32. Further, the rotary knob 10 comprises a spring-supported locating element 15 engaged in one of the bottom recess 35 to retain the rotary knob 10 to the locating block 33.

The sleeve 20 is prepared from a flexible material, for example, nylon, having a plurality of anti-slip ribs 22 spaced around the periphery for positive gripping of the hand, and a plurality of longitudinal rails 24 spaced around the inside wall thereof corresponding to the longitudinal grooves 13 of the rotary knob 10. As shown in FIGS. 2 and 3, the sleeve 20 is sleeved onto the locating block 33 at the bottom end of the outer tube 32 and the coupling portion 11 of the rotary knob 10. The shape of the cross section of the sleeve 20 fits the shape of the cross section of the locating block 33. The longitudinal rails 24 of the sleeve 20 are respectively coupled to the longitudinal grooves 13 of the rotary knob 10. When rotating the sleeve 20 relative to the locating block 33, the longitudinal rails 24 drive the rotary knob 10 to rotate with the sleeve 20.

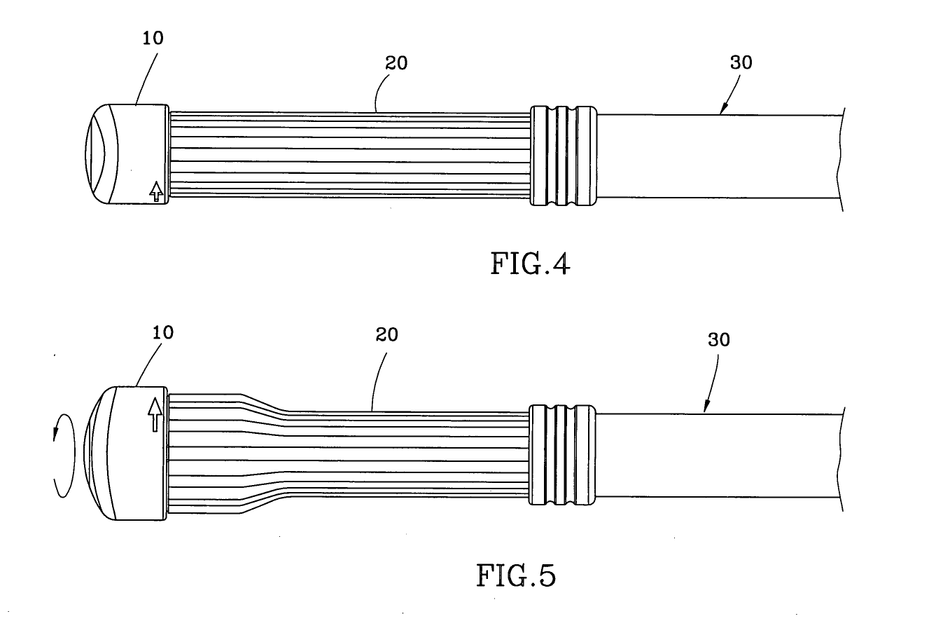

Referring to FIGS. 4 and 5 and FIGS. 1 and 3 again, after installation of the tube set 30 in a hand tool, the user can hold the sleeve 20 to control and operate the hand tool. By means of the flexible material property and the anti-slip ribs 22 of the sleeve 20, the user can hold the sleeve 20 to control and operate the hand tool comfortably and positively. When wishing to change the length of the tube set 30, as shown in FIG. 5, rotate the sleeve 20 relative to the locating block 33 with the hand. At this time, the rotary knob 10 is forced to rotate the inner tube 31 relative to the outer tube 32 from the engagement position to the disengagement position for allowing adjustment of the length of the tube set 30. After adjustment of the length of the tube set 30, the sleeve 20 is rotated in the reversed direction to move the inner tube 31 into engagement with the outer tube 32 again.

What is claimed is:

1. A retractable handle control structure used in a retractable handle comprised of a tube set and a positioning device, the retractable handle control structure comprising:
a rotary knob connected to one end of the tube set of said retractable handle and rotatable by an external force to move said positioning device between a locking position and an unlocking position to lock and unlock said tube set for controlling adjustment of the length of said tube set; and
a sleeve sleeved onto said tube set and connected to said rotary knob for turning by the user to rotate said rotary knob and to further move said positioning device between said locking position and said unlocking position.

2. The retractable handle control structure as claimed in claim 1, wherein said rotary knob comprises at least one outside groove; said sleeve comprises at least one inside rail respectively coupling to the at least one outside groove of said rotary knob.

3. The retractable handle control structure as claimed in claim 1, wherein said sleeve comprises a plurality of anti-slip ribs at a periphery thereof.

4. The retractable handle control structure as claimed in claim 1, wherein said sleeve has a non-circular cross section when said sleeve is sleeved onto said tube set.

5. The retractable handle control structure as claimed in claim 1, wherein said sleeve is made of a flexible material and fits the shape of the cross section of said tube set when said sleeve is sleeved onto said tube set.

6. The retractable handle control structure as claimed in claim 5, wherein said sleeve is made of nylon.

7. The retractable handle control structure as claimed in claim 1, wherein said rotary knob comprises a coupling portion inserted into one end of said sleeve, a hook extending from one end of said coupling portion and pivotally fastened to said tube set.
